(19) United States
(12) Patent Application Publication
(10) Pub. No.: US 2025/0291553 A1
(43) Pub. Date: Sep. 18, 2025

(54) SOURCE CODE COLLABORATION VIA REPLICATED DATA TYPES

(71) Applicant: Microsoft Technology Licensing, LLC, Redmond, WA (US)

(72) Inventor: Aish Raj DAHAL, Fremont, CA (US)

(21) Appl. No.: 18/608,593

(22) Filed: Mar. 18, 2024

(51) Int. Cl. G06F 8/30

(52) U.S. Cl. CPC G06F 8/30

(57) ABSTRACT

Some embodiments provide or utilize code-quality-focused replicated data type functionality for collaborative source code editing support. Some embodiments combine replicated data types with automated quality assessments of potential resolutions of source code update conflicts. The replicated data types support strong eventual consistency of copies of source code, even without a repository or other centralized facility. The quality assessments apply source code quality criteria, such as syntactic correctness, consistency with other source code, programming style criteria, and other measures of source code quality. Deterministic resolution rules are applied, such as last-write-wins, grow-only, or observed-remove, with various replicated data types. Some embodiments prompt a machine learning model for snippet quality assessments, for recommended snippets, or for both.

### BACKGROUND

Many computer software programs are created, or modified, by multiple people who collaborate to collectively accomplish one or more goals. Computing technology provides or supplements collaboration in software development and many other fields, in a wide variety of ways. Collaboration is made possible, or is improved, by functionality such as websites, email, text messaging, videoconferencing, project management tools, software repositories, file sharing platforms, social media, and more. However, there is still room for advancement in collaboration technology, both generally and in the field of collaborative software development.

### SUMMARY

Some embodiments address technical challenges arising from efforts to improve collaboration support for software developers. One challenge is how to share source code edits when a centralized source code repository is not available. Another challenge is how to resolve conflicts between source code edits that were made by different developers. Other technical challenges are also addressed herein.

Some embodiments taught herein provide or utilize code-quality-focused replicated data type functionality, which is also referred to here as QFRDT functionality. Some embodiments combine replicated data types with automated quality assessments of potential resolutions of source code update conflicts. The replicated data types provide strong eventual consistency of copies of source code, even without a repository or other centralized facility. The quality assessments enforce source code quality criteria, such as syntactic correctness, consistency with surrounding source code, and other measures of source code quality. Accordingly, even when internet connectivity is lost or a source code repository is otherwise unavailable, developers can continue editing a local copy of their code, and their development tools can share the changes with other developers who are working elsewhere on the same project.

Other technical activities, technical characteristics, and technical benefits pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. Subject matter scope is defined with claims as properly understood, and to the extent this Summary conflicts with the claims, the claims should prevail.

### BRIEF DESCRIPTION OF THE DRAWINGS

A more particular description will be given with reference to the attached drawings. These drawings only illustrate selected aspects and thus do not fully determine coverage or scope.

FIG. 1 is a diagram illustrating aspects of computer systems and also illustrating configured storage media, including some aspects generally suitable for embodiments which include or use QFRDT functionality;

FIG. 2 is a block diagram illustrating aspects of a family of enhanced systems which are each configured with QFRDT functionality;

FIG. 3 is a block diagram illustrating aspects of another family of systems which are each enhanced with QFRDT functionality, including some systems with software which upon execution performs a QFRDT method;

FIG. 4 is a block diagram illustrating some additional aspects of QFRDT functionality;

FIG. 5 is a block diagram illustrating some aspects or examples related to replicated data types (RDTs);

FIG. 6 is a block diagram illustrating some additional aspects of source code quality criteria;

FIG. 7 is a flowchart illustrating some QFRDT methods; and

FIG. 8 is a flowchart further illustrating QFRDT methods, and incorporating as options the steps of FIGS. 2, 3, and 7.

### DETAILED DESCRIPTION

### Overview

Some teachings described herein were motivated by technical challenges faced and insights gained during efforts to improve technology for integrated development environment (IDE) tools. These challenges and insights provided some motivations, but the teachings herein are not limited in their scope or applicability to these particular tools, motivational challenges, solutions, or insights.

In some scenarios, software developers are editing copies of the same source code file on different machines in respective local IDEs or other local source code editing tools. Different developers sometimes make conflicting edits to a given piece of source code. Indeed, a particular developer sometimes makes conflicting edits at a given location, or at different locations, when work on a file is interrupted. One approach to resolving those conflicts involves merging source code versions into a repository, e.g., through a command such as a git merge command.

However, sometimes the repository is not available because internet connectivity is intermittent or lost, and sometimes no repository is being used. Moreover, a repository is a centralized conflict resolution point, and sometimes an alternative architecture that does not rely on a centralized conflict resolution point would be beneficial. For example, in some peer-to-peer architectures, conflict resolution could be performed at multiple locations. A non-centralized architecture such as a peer-to-peer architecture sometimes permits better resiliency, security, or scalability than a centralized architecture. In some scenarios a peer-to-peer architecture is overlaid on a client-server architecture, in which a repository runs on a central server and the clients communicate both with the repository (when connectivity permits) and with other clients (as peers).

Some embodiments taught herein provide or utilize a peer-to-peer architecture which uses CRDTs to provide strong eventual consistency among different copies of a source code file. The peer-to-peer architecture is stand-alone, or is overlaid on a client-server architecture, depending on the particular embodiment. The acronym CRDT stands for different things in computing technology literature. As used herein, unless stated otherwise CRDT means “commutative replicated data type” or “conflict-free replicated data type” or both. CRDTs are examples of RDTs (replicated data types).

A problem with many CRDTs is that the way they would resolve source code update conflicts would not necessarily produce good source code. For example, suppose a CRDT resolves conflicting updates through a last-write-wins mechanism. Under that mechanism, when two updates conflict, the conflict is resolved by selecting whichever update is the most recent. Consider a text editor that uses such CRDTs, with last-write-wins, to represent text string edits in a natural language text file. Suppose one update would change “Be ready” to “Be organized” and a later update would change the same string “Be ready” to “Be prepared”. This CRDT mechanism would ignore or override the earlier update and resolve the conflict by changing the string according to the later update, with the result “Be prepared”. This resolution is unlikely to cause any problems that are detectable by automatic means.

Now suppose the same CRDT conflict resolution mechanism receives conflicting updates to a text which is a source code text. Of these updates, the earlier update would change “import numpy” to “import numpy as np” (with “as”) and the later update would change “import numpy” to “import numpy aas np” (with “aas”). Under the CRDT's last-write-wins resolution, the later update is chosen, even though it is syntactically wrong. The updates are treated as if they involve nothing more than character strings like “Be ready”, when in fact they involve source code snippets. Similarly, if the later update would change “import numpy” to “import numpy as mp” it would be selected, even when the identifier mp is not consistent with uses of an identifier np in surrounding code. As yet another example, if the later update would change “import numpy” to “import pynum as np” it would still be selected, even though the correct library name is “numpy” not “pynum”.

In short, a CRDT conflict resolution mechanism that treats source code as mere strings, instead of treating it as source code, does not reliably produce “good” source code when resolving edit conflicts. The meaning of “good” varies according to the situation, but some examples of criteria that correspond to goodness in source code include identifier consistency, library name consistency, and syntactic correctness. Additional criteria, referred to as code quality criteria or code acceptance criteria, are also discussed herein.

By contrast, some embodiments taught herein utilize or provide an update conflict resolution mechanism which assesses proposed conflict resolutions against one or more source code acceptance criteria such as syntactic correctness or consistency with other source code, for example. These source code quality assessments help determine update selections, together with CRDT representations of source code updates, in peer-to-peer architectures that provide strong eventual consistency for source code copies edited concurrently at multiple locations. Accordingly, the architectures are also referred to as quality-focused replicated data type (QFRDT) architectures, where the quality involved is source code quality as measured by specified acceptance criteria. Some of these QFRDT architectures transmit, receive, consider, and apply updates to source code that is also versioned using a repository, but a repository is optional in any given embodiment unless stated otherwise.

Some embodiments described herein utilize or provide a QFRDT method of collaborative software development, which includes automatically: locating at least two updates to a replicated data type which represents at least one source code snippet, assessing at least one candidate resolution of a conflict between the updates against at least one source code acceptance criterion, and executing a deterministic conflict resolution in response to at least a result of the assessing.

This QFRDT functionality has the technical benefit of sharing source code edits between different developer locations when a centralized source code repository is unavailable, e.g., due to an outage or a denial-of-service attack. For example, when the individual developer locations still have internet connectivity but the repository does not, it is possible to share updates among the developer locations using QFRDT functionality. If desired, changes made via QFRDT updates are merged into the repository later when the repository becomes available again. Moreover, in some embodiments changes that are not deemed suitable for submission to the repository in a commit command are shared via QFRDT updates. A related technical benefit is that a conflict between source code edits that were made by different developers is resolved by the QFRDT functionality in a way that not only provides strong eventual consistency but also satisfies source code acceptance criteria.

In some embodiments, the assessing includes: provisionally performing each of a plurality of conflicting updates to produce respective provisionally updated source code snippets, ranking each provisionally updated source code snippet according to at least one source code acceptance criterion, identifying a best ranked update according to at least the ranking, and specifying the conflict resolution as acceptance of the best ranked update and rejection of the other conflicting updates.

This QFRDT functionality has the technical benefit of providing a decision framework in which the source code acceptance criteria are explicit, and the quality of each possible update in a set of conflicting updates is quantified according to the source code acceptance criteria. For example, suppose one update would insert “foo (retries)”, another update would insert “foo (retry)”, code near the insertion point uses the identifier “retries” and does not use the identifier “retry”, and an acceptance criterion is identifier consistency. Then the update representing “foo (retries)” would score better than the other update. Another benefit is that the better scoring update is more likely to reflect developers' intentions, because it is more consistent with those intentions as they are manifested in the source code's use of identifiers.

In some embodiments, a condition of the source code acceptance criterion specifies that the candidate resolution includes a candidate source code snippet which is syntactically correct. This QFRDT functionality has the technical benefit of promoting strong eventual consistency of the source code while reducing or avoiding syntax errors in the source code.

In some embodiments, a condition of the source code acceptance criterion specifies that the candidate resolution includes a candidate source code snippet which is in a same programming style as a context source code. Style is defined in a given embodiment, e.g., in terms of whitespace usage conventions, line termination, capitalization conventions, statements-per-line conventions, guidelines on the use of particular programming language features, routine sizes, dependency recital ordering, and potentially many other rules. This QFRDT functionality has the technical benefit of promoting strong eventual consistency of the source code while reducing or avoiding departures from a prevailing or specified style of the source code. Consistency in a codebase facilitates understanding the source code of the codebase, and facilitates modifying that source code efficiently and correctly.

In some embodiments, assessing the candidate resolution includes automatically: submitting an assessment prompt to a language model, the assessment prompt representing at least a portion of the candidate resolution, the assessment prompt specifying the source code acceptance criterion and requesting an assessment of the candidate resolution against the source code acceptance criterion; getting from the language model at least a portion of the result of the assessing; and executing the deterministic conflict resolution in response to at least the portion of the result of the assessing.

This QFRDT functionality has the technical benefit of increasing source code quality and developer productivity, by automatically and proactively assessing source code quality against specified criteria when the source code is being edited. By leveraging language model functionality for quality control as an integrated activity within source code editing, this QFRDT functionality corrects or prevents errors or undesirable departures from quality guidelines. Moreover, in scenarios where each of the conflicting edits was intentionally entered at a location by a developer (as opposed, e.g., to being output by a source generator), the QFRDT conflict resolution has the technical benefit of representing the intent of at least one developer. As a consequence, no spontaneous language model hallucinations are entered into the source code even though a language model is in use.

Some embodiments include automatically: submitting a generation prompt to a language model, the generation prompt representing at least the updates, the generation prompt requesting a candidate source code snippet of the candidate resolution; receiving the candidate source code snippet of the candidate resolution from the language model; and assessing at least the candidate source code snippet of the candidate resolution against the at least one source code acceptance criterion.

This QFRDT functionality has the technical benefit of increasing developer productivity, by automatically and proactively resolving update conflicts within the confines of specified source code quality criteria. By leveraging language model functionality for quality-controlled conflict resolution as an integrated activity within source code editing, this QFRDT functionality corrects or prevents errors or undesirable departures from quality guidelines.

These and other benefits will be apparent to one of skill from the teachings provided herein.

### Operating Environments

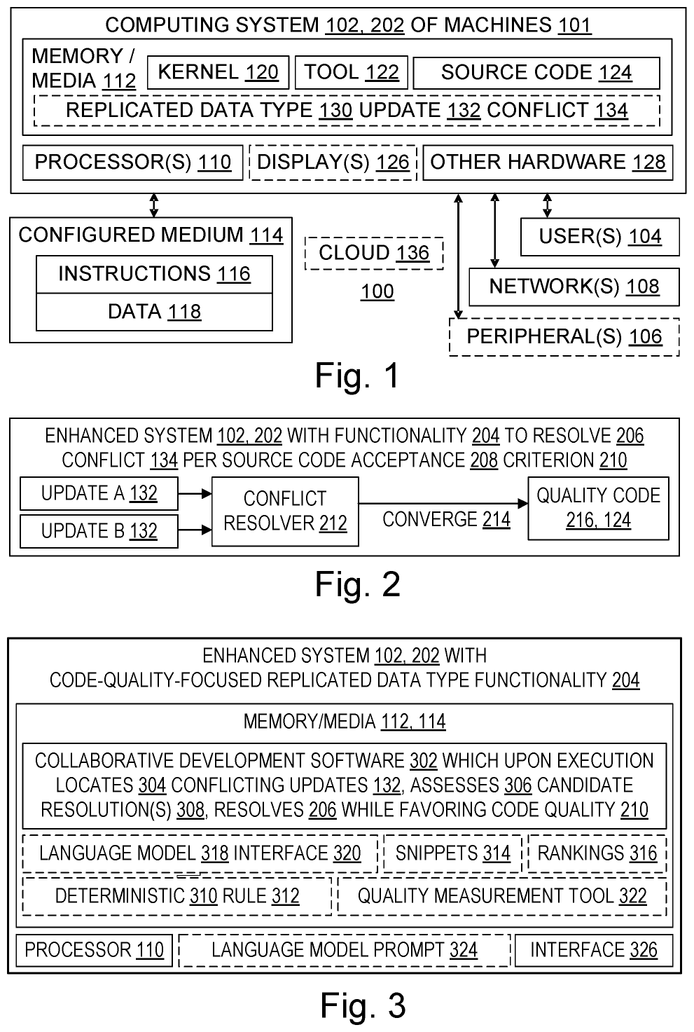

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 136. An individual machine is a computer system, and a network or other non-empty group of cooperating machines is also a computer system. A given computer system 102 may be configured for end-users, e.g., with applications, for administrators, as a server, as a distributed processing node, and/or in other ways.

Human users 104 sometimes interact with a computer system 102 user interface by using displays 126, keyboards 106, and other peripherals 106, via typed text, touch, voice, movement, computer vision, gestures, and/or other forms of I/O. Virtual reality or augmented reality or both functionalities are provided by a system 102 in some embodiments. A screen 126 is a removable peripheral 106 in some embodiments and is an integral part of the system 102 in some embodiments. The user interface supports interaction between an embodiment and one or more human users. In some embodiments, the user interface includes one or more of: a command line interface, a graphical user interface (GUI), natural user interface (NUI), voice command interface, or other user interface (UI) presentations, presented as distinct options or integrated.

System administrators, network administrators, cloud administrators, security analysts and other security personnel, operations personnel, developers, testers, engineers, auditors, and end-users are each a particular type of human user 104. In some embodiments, automated agents, scripts, source code generators, playback software, devices, and the like running or otherwise serving on behalf of one or more humans also have user accounts, e.g., service accounts. Sometimes a user account is created or otherwise provisioned as a human user account but in practice is used primarily or solely by one or more services; such an account is a de facto service account. Although a distinction could be made, “service account” and “machine-driven account” are used interchangeably herein with no limitation to any particular vendor.

Storage devices or networking devices or both are considered peripheral equipment in some embodiments and part of a system 102 in other embodiments, depending on their detachability from the processor 110. In some embodiments, other computer systems not shown in FIG. 1 interact in technological ways with the computer system 102 or with another system embodiment using one or more connections to a cloud 136 and/or other network 108 via network interface equipment, for example.

Each computer system 102 includes at least one processor 110. The computer system 102, like other suitable systems, also includes one or more computer-readable storage media 112, also referred to as computer-readable storage devices 112. In some embodiments, tools 122 include source code generators, security tools, or software applications, on mobile devices 102 or workstations 102 or servers 102, editors, compilers, debuggers and other software development tools, as well as APIs, browsers, or webpages and the corresponding software for protocols such as HTTPS, for example. Files, APIs, endpoints, and other resources may be accessed by an account or non-empty set of accounts, user or non-empty group of users, IP address or non-empty group of IP addresses, or other entity. Access attempts may present passwords, digital certificates, tokens or other types of authentication credentials.

Storage media 112 occurs in different physical types. Some examples of storage media 112 are volatile memory, nonvolatile memory, fixed in place media, removable media, magnetic media, optical media, solid-state media, and other types of physical durable storage media (as opposed to merely a propagated signal or mere energy). In particular, in some embodiments a configured storage medium 114 such as a portable (i.e., external) hard drive, CD, DVD, memory stick, or other removable nonvolatile memory medium becomes functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory nor a computer-readable storage device is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, volumes, and so forth. Such data is also transformed by backup, restore, commits, aborts, reformatting, and/or other technical operations.

Although an embodiment is described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, some embodiments include one of more of: chiplets, hardware logic components 110, 128 such as Field-Programmable Gate Arrays (FPGAs), Application-Specific Integrated Circuits (ASICs), Application-Specific Standard Products (ASSPs), System-on-a-Chip components, Complex Programmable Logic Devices (CPLDs), and similar components. In some embodiments, components are grouped into interacting functional modules based on their inputs, outputs, or their technical effects, for example.

In addition to processors 110 (e.g., CPUs, ALUs, FPUs, TPUs, GPUs, and/or quantum processors), memory/storage media 112, peripherals 106, and displays 126, some operating environments also include other hardware 128, such as batteries, buses, power supplies, wired and wireless network interface cards, for instance. The nouns “screen” and “display” are used interchangeably herein. In some embodiments, a display 126 includes one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which are present in some computer systems. In some, virtualizations of networking interface equipment and other network components such as switches or routers or firewalls are also present, e.g., in a software-defined network or a sandboxed or other secure cloud computing environment. In some embodiments, one or more computers are partially or fully “air gapped” by reason of being disconnected or only intermittently connected to another networked device or remote cloud. In particular, QFRDT functionality 204 could be installed on an air gapped network 108 and then be updated periodically or on occasion using removable media 114, or not be updated at all. Some embodiments also communicate technical data or technical instructions or both through direct memory access, removable or non-removable volatile or nonvolatile storage media, or other information storage-retrieval and/or transmission approaches.

One of skill will appreciate that the foregoing aspects and other aspects presented herein under “Operating Environments” form part of some embodiments. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but interoperate with items in an operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current disclosure.

In any later application that claims priority to the current application, reference numerals may be added to designate items disclosed in the current application. Such items may include, e.g., software, hardware, steps, processes, systems, functionalities, mechanisms, devices, data structures, kinds of data, settings, parameters, components, computational resources, programming languages, tools, workflows, or algorithm implementations, or other items in a computing environment, which are disclosed herein but not associated with a particular reference numeral herein. Corresponding drawings may also be added.

More about Systems

FIG. 2 illustrates a computing system 102 configured by one or more of the QFRDT functionality enhancements taught herein, resulting in an enhanced system 202. In some embodiments, this enhanced system 202 includes a single machine, a local network of machines, machines in a particular building, machines used by a particular entity, machines in a particular datacenter, machines in a particular cloud, or another computing environment 100 that is suitably enhanced. FIG. 2 items are discussed at various points herein.

FIG. 3 shows some aspects of some enhanced systems 202. Like FIG. 2, FIG. 3 is not a comprehensive summary of all aspects of enhanced systems 202 or all aspects of QFRDT functionality 204. Nor is either figure a comprehensive summary of all aspects of an environment 100 or system 202 or other context of an enhanced system 202, or a comprehensive summary of any aspect of functionality 204 for potential use in or with a system 102. FIG. 3 items are discussed at various points herein.

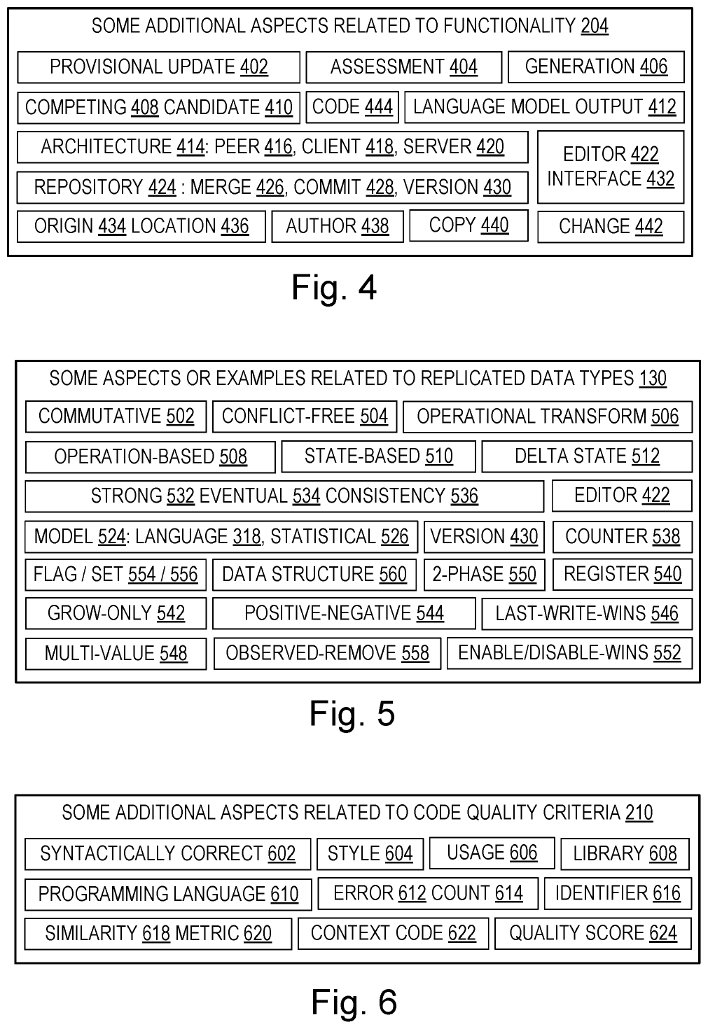

FIG. 4 shows some additional aspects of QFRDT functionality 204. This is not a comprehensive summary of all aspects of QFRDT functionality 204. FIG. 4 items are discussed at various points herein.

FIG. 5 shows some additional aspects of replicated data types (the “RDT” in “QFRDT”). This is not a comprehensive summary of all aspects of replicated data types 130. FIG. 5 items are discussed at various points herein.

FIG. 6 shows some additional aspects of code quality criteria 210 (criteria defining the “QF” quality focus in “QFRDT”). This is not a comprehensive summary of all aspects of code quality. FIG. 6 items are discussed at various points herein.

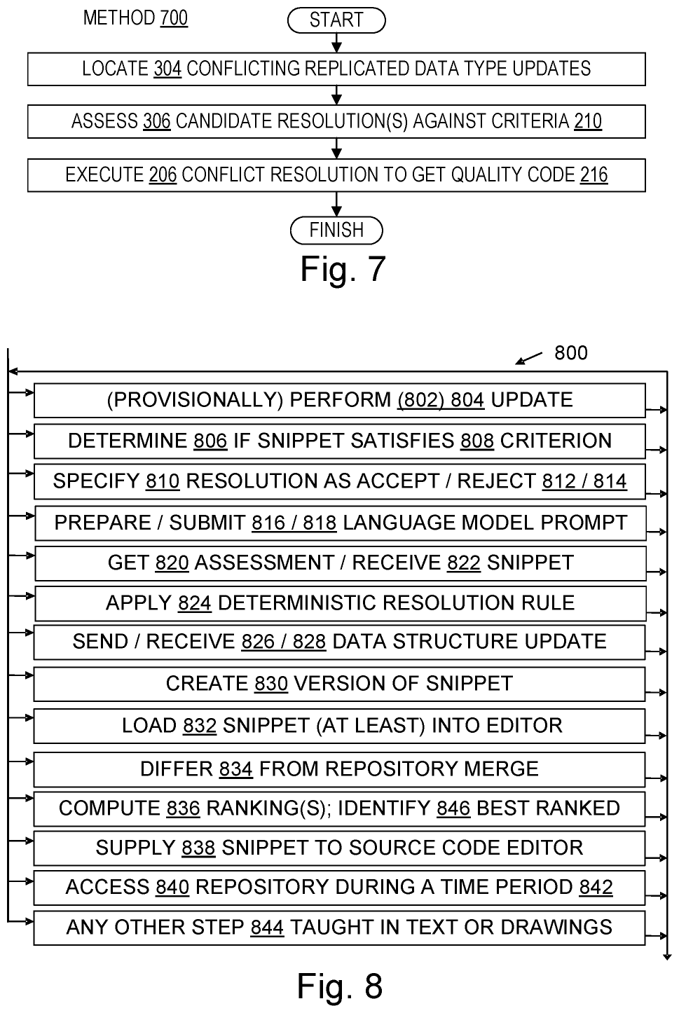

The other figures are also relevant to systems 202. FIGS. 7 and 8 are flowcharts which illustrate some methods of QFRDT functionality 204 operation in some systems 202.

In some embodiments, the enhanced system 202 is networked through an interface 326. In some, an interface 326 includes hardware such as network interface cards, software such as network stacks, APIs, or sockets, combination items such as network connections, or a combination thereof.

Some embodiments include a collaborative software development computing system 202 which is configured to utilize or provide functionality 204. The system 202 includes a digital memory set 112 including at least one digital memory 112, and a processor set 110 including at least one processor 110. The processor set is in operable communication with the digital memory set. A digital memory set is a set which includes at least one digital memory 112, also referred to as a memory 112. The word “digital” is used to emphasize that the memory 112 is part of a computing system 102, not a human person's memory. The word “set” is used to emphasize that the memory 112 is not necessarily in a single contiguous block or of a single kind, e.g., a memory 112 may include hard drive memory as well as volatile RAM, and may include memories that are physically located on different machines 101. Similarly, the phrase “processor set” is used to emphasize that a processor 110 is not necessarily confined to a single chip or a single machine 101. Sets are non-empty unless described otherwise.

In this example, the at least one processor 110 is configured to execute a collaborative software development method 800, the method including: locating 304 at least two updates 132 to a replicated data type 130 which represents at least one source code snippet 314, assessing 306 at least one candidate resolution 308 of a conflict 134 between the updates against at least one source code acceptance 208 criterion 210, and executing 206 a deterministic conflict resolution 308 in response to at least a result 404 of the assessing 306. In some embodiments, one or more of the assessing 306 and the resolving 206 are implemented as part of a CRDT's hard-coded internal merge algorithm.

In some embodiments, one or more of the assessing 306 and the resolving 206 are performed by a conflict resolver 212. Location 304 is performed, e.g., via an API. Acceptance 208 refers to suitability or acceptability, that is, quality as represented by the acceptance criteria 210, not to any particular action. Source code which meets acceptance criteria is referred to as quality code 216, or as “good” code.

In one example scenario, an embodiment locates 304 a first update 132 representing a source code snippet “import pandas as p” in an instance of an RDT and also locates 304 a second update 132 representing a source code snippet “import pandas asp” in another instance of the RDT. Each snippet represents a candidate resolution 308 in which one update is performed locally and the other update is rejected locally. The embodiment assesses 306 each snippet 314 against a syntactic correctness criterion 602, 210 by invoking a Python programming language tool 122, e.g., a lexical analysis and parsing portion of a Python interpreter 122. The assessment results 404 indicate that “import pandas as p” is syntactically correct but “import pandas asp” is not. The embodiment responds to the assessment results by executing 206 a deterministic conflict resolution 308 which performs the update that gives syntactically correct source code and does not perform the competing 408 conflicting update that would have produced syntactically incorrect source code.

This conflict resolution 308 is deterministic 310. In part, the resolution is deterministic because it operates on RDTs which incorporate or use one or more deterministic mechanisms such as last-write-wins 546 or observed-remove 558. The resolution is also deterministic because the syntax checking tool 122 will always determine, at least during an entire relevant collaborative source code editing period 842, that “import pandas as p” is syntactically correct and “import pandas asp” is not syntactically correct.

Unless stated otherwise, the quality assessment result 404 takes precedence over conflict resolution mechanisms, such as last-write-wins 546 or observed-remove 558, that are not focused specifically on source code quality. That is, adherence to source code quality criteria 210 governs over a resolution that is based on criteria other than source code quality.

For instance, assume that in the example scenario above the RDTs default to a built-in last-write-wins 546 resolution mechanism, and assume that the syntactically incorrect “import pandas asp” update is the more recent of the two updates. Without the quality assessment result 404 taking precedence, the syntactically incorrect “import pandas asp” update would have been selected, which is not the best outcome so far as source code quality is concerned. However, because the quality assessment result 404 does take precedence over the more general last-write-wins 546, the syntactically correct “import pandas as p” update is selected, even though it was not the more recent of the two updates.

As a further illustration, consider a scenario in which two updates received at a location each represent a respective syntactically correct snippet. For example, one update represents “import pandas as p” and the other update represents “import pandas as pn”. In this scenario, when the embodiment assesses 306 the snippets 314 against the syntactic correctness criterion 602, 210, the syntax checking tool 122 assessment results 404 will indicate that each snippet is syntactically correct. Then the embodiment will execute 206 a deterministic conflict resolution 308 in response to both the assessment results 404 and other data, e.g., by selecting a last-write-wins 546 resolution based on timestamp data. If the update representing “import pandas as pn” has the later timestamp of the two updates, then that update will be selected to resolve the conflict.

The examples above utilize Python source code 124, two updates 132, and a syntactic correctness 602 criterion. However, one of skill will understand that the teachings herein also apply to source code 124 in other programming languages, also apply with more than two updates, also apply when more than two quality criteria 210 are being enforced, and also apply when one or more criteria 210 other than syntactic correctness are being employed.

Some embodiments include an interface 320, 326 to a language model 318, and the processor 110 is further configured to perform at least one of: preparing 816 a generation 406 prompt 324 which requests a candidate source code snippet 314 of the candidate resolution 308, submitting 818 the generation prompt to the language model via the interface, and receiving 822 the candidate source code snippet from the language model via the interface; or preparing 816 an assessment 404 prompt 324 which contains a candidate 410 source code snippet 314 of the candidate 410 resolution 308, submitting 818 the assessment prompt to the language model via the interface, and getting 820 a quality assessment 404, 412 of the candidate source code snippet from the language model via the interface.

In one scenario, an embodiment locates three conflicting updates, and prepares a generation prompt 324 which includes a text along the lines of “You are an expert at merging source code edits. Three possible edits to a Python source code file are shown below, together with some additional Python source code for context. Which edit is syntactically correct and also best matches the style and content of the context source code?” The context source code is copied from the source code near the insertion point of the update edits. After submitting 818 the prompt via the interface, the embodiment receives 822 a source code snippet selection 412 from the language model via the interface. The embodiment selects the corresponding update to resolve 206 the conflict.

In some cases, a language model 318 will give different responses to different submissions of the same prompt. This occurs sometimes when a prompt lacks sufficient examples to illustrate a goal, e.g., when an LLM is asked whether a candidate resolution is “consistent” with other source code but examples of consistency are not provided in the prompt. In a variation to promote determinism 310, the same prompt is submitted N times, and the update 132 that matches a majority of the corresponding model-generated snippet choices is selected to resolve 206 the conflict. Alternatively, the same prompt is submitted until the same snippet is selected by the language model M times in a row. If a maximum number S of submissions of the prompt has occurred without the same snippet being selected M times in a row, conflict resolution is performed without using any of the language model's recommendations.

In one scenario, an embodiment prepares an assessment prompt 324 for each update, which includes a text along the lines of “A Python source code snippet is shown below, together with some additional Python source code for context. What score do you give this snippet, from 0 meaning worst match to 10 meaning best match, based on how well the snippet matches the style and the content of the context source code?” After submitting 818 the prompt via the interface, the embodiment receives 822 a source code snippet assessment 404 from the language model via the interface, for each update. The embodiment tests the snippets separately for syntactic correctness, and selects the highest scored syntactically correct update to resolve 206 the conflict.

Some embodiments include an interface 326 to a source code quality measurement module 322, and the processor 110 is further configured to submit 818 a candidate source code snippet of the candidate resolution to the source code quality measurement module via the interface, and to get 820 a quality assessment 404 of the candidate source code snippet from the source code quality measurement module via the interface.

In some embodiments, the source code quality measurement module 322 includes one or more of: a large language model 318, 524, a statistical model 526, 524, a lexical analysis and parsing tool 122, a linting tool 122, a static analysis tool 122, a source code similarity measurement tool 122, a security vulnerability detection tool 122, a build dependency identification tool 122, a programming style departure identification tool 122, a performance profiler 122, or a spell checker 122 which includes or uses a dictionary 122 of identifiers extracted from a source code base 124.

In some embodiments, multiple tools 322 are potentially executed during a given assessment 306. In some embodiments, the quality measurement tools 322 are prioritized relative to one another, e.g., in order to perform computationally cheaper tests such as a syntax correctness check before performing computationally more expensive tests such as a test that invokes a large language model. In some embodiments, the quality measurement tools 322 are prioritized relative to one another, e.g., in order to perform tests for more important criteria 210 before tests of criteria 210 that are deemed less important.

In some embodiments, the replicated data type 130 includes at least one of: a commutative replicated data type 502, a conflict-free replicated data type 504, an operational transform replicated data type 506, an operation-based replicated data type 508, a state-based replicated data type 510, or a delta state replicated data type 512.

In some embodiments, the replicated data type 130 includes at least one of: a grow-only 542 counter 538, a positive-negative 544 counter 538, a last-write-wins 546 register 540, a multi-value 548 register 540, a grow-only 542 set 556, a two-phase 550 set 556, an enable-wins 552 flag 554, a disable-wins 552 flag 554, a grow-only 542 data structure 560, or an observed-remove 558 data structure 560.

In some embodiments, the deterministic conflict resolution 206 includes at least one of: a last-write-wins 546 conflict resolution 206 or an observed-remove 558 conflict resolution 206. Under a last-write-wins rule, the most recent update wins. Under an observed-remove rule, a delete only works to delete something from a replica if the replica had that thing when the delete was ordered.

In some embodiments, the collaborative software development computing system 202 is configured as a peer 416 in a peer-to-peer architecture 414. In some embodiments, the collaborative software development computing system 202 is configured as a client 418 in a client-server architecture 414. In some embodiments, the collaborative software development computing system 202 is configured as a server 420 in a client-server architecture 414. In some embodiments, the collaborative software development computing system 202 is configured as both a peer and a client, and in some the system 202 is configured as both a peer and a server.

In some embodiments, the collaborative software development computing system includes a source code editor 422 having a user interface 432, and executing 206 the deterministic conflict resolution creates 830 a version 430 of the at least one source code snippet, and the at least one processor 110 is configured to upon execution load 832 the created version into the source code editor user interface 432.

Other system embodiments are also described herein, either directly or derivable as system versions of described processes or configured media, duly informed by the extensive discussion herein of computing hardware.

Although specific QFRDT architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different kinds of QFRDT functionality, for example, as well as different technical features, aspects, mechanisms, software, expressions, operational sequences, commands, data structures, programming environments, execution environments, environment or system characteristics, or other functionality consistent with teachings provided herein, and may otherwise depart from the particular examples provided.

Processes (a.k.a. Methods)

Processes (which are also be referred to as “methods” in the legal sense of that word) are illustrated in various ways herein, both in text and in drawing figures. FIGS. 7 and 8 each illustrate a family of methods 700 and 800 respectively, which are performed or assisted by some enhanced systems, such as some systems 202 or another QFRDT functionality enhanced system as taught herein. Method family 700 is a proper subset of method family 800. Moreover, activities identified in block diagrams in FIGS. 2 and 3 include method steps, e.g., converging 214 source code copies toward eventual consistency 536, and steps 304, 306, 206 taken by software 302. These method steps are likewise incorporated into method (a.k.a. process) 800. These diagrams and flowcharts are merely examples; as noted elsewhere, any operable combination of steps that are disclosed herein may be part of a given embodiment when called out in a claim.

Technical processes shown in the Figures or otherwise disclosed will be performed automatically, e.g., by an enhanced system 202, unless otherwise indicated. Related non-claimed processes may also be performed in part automatically and in part manually to the extent action by a human person is implicated. For instance, in some situations a human 104 types or speaks an input which specifies a particular string value for a snippet 314 of source code in one or more programming languages such as HTML, Python, SQL, or other programming languages, or a human 104 enters via user interface 432 a command input such as a snippet editing command, e.g., a paste command or an autocompletion tab command. A result of such input activity is captured in the system 202 as digital text, or captured as digital audio which is then converted to digital text. But no process contemplated as an embodiment herein is entirely manual or purely mental. None of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIG. 8. FIG. 8 is a supplement to the textual and figure drawing examples of embodiments provided herein and the descriptions of embodiments provided herein. In the event of any alleged inconsistency, lack of clarity, or excessive breadth due to an interpretation of FIG. 8, the content of this disclosure shall prevail over that interpretation of FIG. 8.

Arrows in process or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 800 action items are traversed to indicate the steps performed during a process may vary from one performance instance of the process to another performance instance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim of an application or patent that includes or claims priority to the present disclosure. To the extent that a person of skill considers a given sequence S of steps which is consistent with FIG. 8 to be non-operable, the sequence S is not within the scope of any claim. Any assertion otherwise is contrary to the present disclosure.

Some embodiments provide or utilize a collaborative software development method 800 in a computing system 102, e.g., in a node 102 of a computer network 108. This method includes automatically: locating 304 at least two updates 132 to a replicated data type 130 which represents at least one source code snippet 314; assessing 306 at least one candidate resolution 308 of a conflict 134 between the updates against at least one source code acceptance criterion 210; and executing 206 a deterministic 310 conflict resolution 308 in response to at least a result of the assessing, the executing including creating 830 a version 430 of the at least one source code snippet; and supplying 838 the created version to a source code editor 422.

In one example scenario, an embodiment locates an update which represents the following two-line snippet:
import numpy as n
import pandas as p

In this scenario, the embodiment also locates an update which represents the following one-line snippet:
import numpy as n; import pandas as p;

The embodiment recognizes a conflict 134 between the updates, in that the strings of the update snippets are not identical. Both snippets are syntactically correct, although use of semicolons as line terminators in Python source code is generally discouraged. Thus, applying a syntactic correctness criterion 210 would not resolve the conflict.

However, applying a programming style 604 criterion 210 will resolve the conflict. The embodiment compares 306 the usage of semicolons in each update snippet to the usage of semicolons in a context source code 622 which is extracted from a local editor's copy of source code. The context code is extracted by the embodiment from above, or below, or around, an insertion point in the source code that is designated for the insertion 804 of whichever snippet gets chosen, e.g., an insertion point corresponding to the editor's cursor position in the source code file. The semicolon usage style comparison 306 is performed, e.g., by a semicolon counting tool 122, 322, or a language-specific style checking tool 122, 322 such as pycodestyle 122, 322, or a code similarity 618 metric 620 tool 122, 322 such as a MOSS (measure of software similarity) tool 122, 322 or a tool that embeds source codes as vectors and measures a vector distance, or a statistical model 526, 524, or a language model 318, 524.

In this example scenario, the style comparison reveals an absence of semicolons in the context code 622, so the embodiment resolves 206 the conflict by selecting the update whose two-line snippet has no semicolons. Presence or absence of semicolon line terminators in Python source code is a deterministic quality and does not depend on the order of arrival of updates at a given location, so it is compatible with convergence to strong eventual consistency of source code that is undergoing updates.

In some embodiments, the assessing 306 includes: provisionally performing 802 a first one of the two updates to produce a first provisionally updated source code snippet 402, 314; provisionally performing 802 a second one of the two updates to produce a second provisionally updated source code snippet 402, 314; determining 806 that the first provisionally updated source code snippet satisfies 808 the source code acceptance criterion 210 and determining 806 that the second provisionally updated source code snippet does not satisfy the source code acceptance criterion; and specifying 810 the conflict resolution 308 as an acceptance 812 of the first one of the two updates and a rejection 814 of the second one of the two updates. Here, and elsewhere herein, “first” and “second” are used to distinguish items, not to require any particular order. So, the second update could actually be provisionally performed before the first update in some cases, or they could both be provisionally performed concurrently.

In some embodiments, a provisional performance 802 performs the update without inserting it into the copy of the source code that is being edited. For example, in some cases provisionally performing 802 extracts the snippet string from the update data structure, or (re) constructs the snippet string from data in the update data structure, without also inserting the result into the local source code copy in the editor 422 user interface 432.

In some embodiments, the assessing 306 includes: provisionally performing 802 each of a plurality of conflicting updates 132 to produce respective provisionally updated source code snippets 402, 314; ranking 836 each provisionally updated source code snippet according to at least one source code acceptance criterion; identifying a best ranked update according to at least the ranking 316, 836; and specifying 810 the conflict resolution as acceptance 812 of the best ranked update and rejection 814 of the other conflicting updates.

In one scenario, three conflicting updates are ranked 836, resulting in the following rankings 316 of three corresponding provisional update snippets:
[rank 3]
import numpy as n
import pandas asp
[rank 2]
import numpy as n; import pandas as p;
[rank 1]
import numpy as n
import pandas as p

In this example, syntactic correctness is given greater weight or priority than style. The rank 3 snippet fails to satisfy the syntactically correct 602 criterion 210 (“asp” should be “as p”). The rank 2 snippet is syntactically correct but fails to satisfy a style 604 criterion 210 (semicolon line terminators are not a best stylistic practice in Python). The rank 1 snippet satisfies both the syntactically correct criterion and the style criterion.

Given these rankings, the embodiment in this example identifies 846 the rank 1 snippet as a best ranked update according to the rankings. Then the embodiment specifies 810 the conflict resolution as acceptance 812 of the rank 1 update and rejection 814 of the other two conflicting updates.

In some scenarios, two or more updates get ranked according to the quality of the code each would produce, and the best ranked update wins. If more than one update is ranked best, then an additional deterministic criterion is used, such as numeric order of a hash of each of the N best ranked updates. The term “best” is used to describe rank, instead of “highest”, to emphasize that in some implementations a lower score is better, whereas in other implementations a higher score is better.

In some embodiments, a condition of the source code acceptance criterion 210 specifies at least one of: the candidate resolution includes a candidate source code snippet which is syntactically correct 602; the candidate resolution includes a candidate source code snippet which is in a same programming language 610 as a context source code 622; the candidate resolution includes a candidate source code snippet which is in a same programming style 604 as a context source code; the candidate resolution includes a candidate source code snippet which includes a variable identifier 616 that is also in a context source code (thereby promoting consistent use of variable names); the candidate resolution includes a candidate source code snippet which invokes an imported library 608 that is also invoked in a context source code (thereby promoting consistent use of libraries); the candidate resolution includes a candidate source code snippet which has greater usage 606 in a context source code 622 than any other candidate source code snippet of any competing 408 candidate resolution (based, e.g., on embeddings or on human-readable source code); the candidate resolution includes a candidate source code snippet which has greater similarity 618 to a context source code than any other candidate source code snippet of any competing candidate resolution, where similarity is measured by a specified software similarity metric 620; or the candidate resolution includes a candidate source code snippet which has lower linting tool 322 error 612 count 614 in a context source code than any other candidate source code snippet of any competing candidate resolution (thereby promoting source code that is correct and secure).

In some embodiments, a condition of the source code acceptance criterion 210 specifies that the candidate resolution includes a candidate source code snippet which has a better source code quality measurement tool score 316 from a specified source code quality measurement tool 322 than any other candidate source code snippet of any competing candidate resolution.

To promote determinism 310, some embodiments enforce determinism rules 312. One such rule 312 prioritizes the criteria 210 relative to one another, e.g., in an example above syntactic correctness 602 has a higher priority than stylistic 604 adherence.

Another determinism rule 312 specifies particular tools 122, and in some cases even specifies particular tool versions, for use as quality measurement tools 322. For instance, some embodiments avoid assessing syntactic correctness with a language model at one developer's location 436 when the embodiment is configured to assess syntactic correctness with a compiler or interpreter front end at another developer's location 436. Likewise, when syntactic correctness is assessed with a compiler or interpreter front end as a parsing tool 322 at several locations, the same version of that parsing tool 322 is used at each location 436.

In some embodiments, assessing 306 the candidate resolution includes automatically: submitting 818 an assessment prompt 324 to a language model 318, the assessment prompt representing at least a portion of the candidate resolution, the assessment prompt specifying the source code acceptance criterion 210 and requesting an assessment of the candidate resolution against the source code acceptance criterion; getting 820 from the language model at least a portion of the result 404 of the assessing; and executing 206 the deterministic conflict resolution in response to at least the portion of the result of the assessing.

In one scenario, the assessment prompt includes a query to the model along the lines of “Which of the two source code snippets below is more consistent with the context source code below, where consistency means use of the same names or similar names for variables, classes, libraries, and user-defined constants?” Such a model 318 is trained on source code in whatever programming language is used in the snippets and the context code 622.

In another scenario, the assessment prompt includes a query to the model along the lines of “Which of the two source code snippets below is more consistent with the style examples, style rules, and style guidelines in the PEP 8 Style Guide for Python Code?” Such a model 318 is trained not only on Python source code, but also on the Python style guide referenced in the query.

Some embodiments include automatically: submitting 818 a generation prompt 324 to a language model, the generation prompt representing at least the updates, the generation prompt requesting a candidate source code snippet of the candidate resolution; receiving 822 the candidate source code snippet of the candidate resolution from the language model; and assessing 306 at least the candidate source code snippet of the candidate resolution against the at least one source code acceptance criterion.

In one scenario, the generation prompt includes a request along the lines of the following.
Here are two code snippets:
[snippet 1]
import numpy as n
import pandas asp
[snippet 2]
import numpy as n; import pandas as p;
Generate a code snippet in syntactically correct Python which is better than the code snippets above that will make a computer do, when executed, what the code snippets above try to make a computer do.

In response to the generation prompt, the language model outputs 412 the following snippet:
import numpy as n
import pandas as p

Then the embodiment assesses 306 all three code snippets against at least one source code acceptance criterion, and resolves the conflict between the two update snippets by selecting the third snippet instead of either of the two update snippets.

### Configured Storage Media

Some embodiments include a configured computer-readable storage medium 112. Some examples of storage medium 112 include disks (magnetic, optical, or otherwise), RAM, EEPROMS or other ROMs, and other configurable memory, including in particular computer-readable storage media (which are not mere propagated signals). In some embodiments, the storage medium which is configured is in particular a removable storage medium 114 such as a CD, DVD, or flash memory. A general-purpose memory, which is be removable or not, and is volatile or not, depending on the embodiment, can be configured in the embodiment using items such as replicated data types 130, updates 132, snippets 314, rankings 316, quality measurement tools 322, language model prompts 324, and QFRDT software 302, in the form of data 118 and instructions 116, read from a removable storage medium 114 and/or another source such as a network connection, to form a configured storage medium. The foregoing examples are not necessarily mutually exclusive of one another. The configured storage medium 112 is capable of causing a computer system 202 to perform technical process steps for providing or utilizing QFRDT functionality 204 as disclosed herein. The Figures thus help illustrate configured storage media embodiments and process (a.k.a. method) embodiments, as well as system and process embodiments. In particular, any of the method steps illustrated in FIG. 2, 3, 7, or 8, or otherwise taught herein, may be used to help configure a storage medium to form a configured storage medium embodiment.

Some embodiments use or provide a computer-readable storage device 112, 114 configured with data 118 and instructions 116 which upon execution by a processor 110 cause a computing system 202 to perform a collaborative software development method 800 in a computing system. This method 800 includes automatically: locating 304 at least two updates 132 to a commutative replicated data type 130 which represents at least one source code snippet 314, each update having a respective origin 434 location 436 and a respective author 438, each update representing a respective change 442 made to a respective copy 440 of a source code by the respective author at the respective location, one of the updates being in a conflict 134 with another of the updates; assessing 306 at least one candidate resolution of the conflict between the updates against at least one source code acceptance criterion 210; and executing 206 a deterministic conflict resolution 308 in response to at least a result of the assessing.

In some embodiments, the author 438 is an editor 422 executing on behalf of a user 104. In some embodiments, the author 438 is source code generator 122.

In some embodiments, the origin 434 is where an edit corresponding to an update was first entered in a copy of source code. In other embodiments, the origin 434 is where the update was sent 826 from, and is not necessarily where the edit corresponding to an update was first entered in a copy of source code, because an update can be propagated from location A to location B to location C. Location 436 is specified, e.g., as one or more of an IP address, a machine address, or a user account identifier.

In some embodiments, the computer-readable storage device 114 is characterized by at least one of: each update 132 is received 828 free of a source code repository 424 commit 428 request; neither update 132 is received 828 with an associated source code repository commit 428 identifier; the method avoids sending 826 either update 132 to a source code repository 424 of a version control system; the method is performed outside a source code repository 424 of a version control system; the method provides a strong 532 eventual 534 consistency 536 to multiple versions 430 of a file of source code; the method converges 214 multiple versions of a file of source code on multiple devices; or the method operates independently from any source code repository 424 commit 428 operation.

The foregoing are examples of differences between mechanisms and operation of some embodiments herein and mechanisms and operation of repositories 424 which rely on merge commands 426 or commit commands 428 to handle conflicts between source code versions. Moreover, CRDT uses specific data types such counters, registers, grow-only maps, and associated resolution mechanisms, whereas repository merges operate on arbitrary byte sequences. Due to how CRDTs work, resolution of conflicts happens according to underlying rules of convergence, e.g., last-write-wins in a register. In a repository 424, by contrast, convergence and strong eventual consistency are not enforced by any mechanism.

But unless stated otherwise, repositories 424 and QFRDT embodiments can coexist in a given network 108 as different 834 yet compatible conflict resolution technologies. Each conflict resolution technology can be used by a given set of developers, and each conflict resolution technology can supplement the collaboration functionality provided by the other conflict resolution technology.

In some embodiments, executing 206 the deterministic conflict resolution creates 830 a version 430 of the at least one source code snippet 314, and the method further includes loading 832 the created version into a source code editing tool 422 on the computing system. Edited source code 124 is then compiled or interpreted, thereby generating instructions 116 ultimately translated into executable code 444, which upon execution performs computation in a system 102.

In some embodiments, the method includes at least one of: assessing 306 the at least one candidate resolution 308 against multiple source code acceptance criteria; or ranking 836 each of a plurality of candidate resolutions according to the at least one source code acceptance criterion 210, and resolving 206 the conflict between the updates according to a best-ranked candidate resolution 308.

In some embodiments, a respective instance of the method is performed by the respective author 438 at the respective location 436 by a respective tool 122 during a time period 842 in which access 840 to a repository 424 which contains at least one version 430 of the source code is unavailable at each respective location. In particular, in some scenarios developers can continue editing a local copy of their shared project source code, and their development tools equipped with QFRDT functionality can share the resulting changes with other developers who are working elsewhere on the same project, even when internet connectivity is lost or a source code repository is otherwise unavailable.

### Machine Learning Models, Including Language Models

A language model 318 or other machine learning model 524 within or utilized by an enhanced system 202 is not necessarily a large language model (LLM) in every embodiment, but it is an LLM in some embodiments. For present purposes, a language model is “large” if it has at least a billion parameters. For example GPT-2 (OpenAI), MegatronLM (NVIDIA), T5 (Google), Turing-NLG (Microsoft), GPT-3 (OpenAI), GPT-3.5 (OpenAI), GPT-4 (OpenAI), and LLAMA versions (Meta AI) are each a large language model (LLM) for purposes of the present disclosure, regardless of any definitions to the contrary that may be present in the industry. Some examples of models 524 include language models which are large language models, large language models (LLMs), multimodal language models, and foundation models.

Language model stability is a consideration in some embodiments and some scenarios. Instability leads to inconsistency in language model responses to prompts 324. Language model stability is sometimes dependent on language model parameters. Some different large language models have different stability parameters, and some exhibit different variability between answers to the same question even while using the same stability parameters. Some models 318 are stabilized by adjusting parameters such as temperature, frequency penalty, presence penalty, or nucleus sampling, and also or instead by constraining the queries sent to a given instance of the model 318. In some scenarios, model performance is optimized by use of suitable training data, fine-tuning, prompt engineering, or a combination thereof.

### Additional Observations

Additional support for the discussion of QFRDT functionality 204 herein is provided under various headings. However, it is all intended to be understood as an integrated and integral part of the present disclosure's discussion of the contemplated embodiments.

One of skill will recognize that not every part of this disclosure, or any particular details therein, are necessarily required to satisfy legal criteria such as enablement, written description, best mode, novelty, nonobviousness, inventive step, or industrial applicability. Any apparent conflict with any other patent disclosure, even from the owner of the present subject matter, has no role in interpreting the claims presented in this patent disclosure. It is in the context of this understanding, which pertains to all parts of the present disclosure, that examples and observations are offered herein.

Some software development tools include a cloud-based integrated development environment (IDE) for which data is stored on cloud servers. Some embodiments taught herein adapt a fully cloud-based solution IDE to a hybrid IDE which also supports editing and sharing source code. In some cases, an IDE equipped with QFRDT functionality eagerly downloads and caches a local version of a user's cloud-based development environment. Edits to source code and other changes are then made on the local contents. In cases where a local code space is only owned by a single user, data synchronization is done by using CRDT in a lazy background manner. The user is able to mount the code space file system locally, and also able to run builds locally, e.g., in a cross-platform way.

Some embodiments provide or utilize an AI-based build and development system that facilitates development along several dimensions.

Some embodiments are cross-platform, in that they run on different operating systems and are able to build and run the same code on different platforms. Some embodiments use a file system in user space (FUSE) that is able to run on different operating systems.

Some embodiments are offline-online, in that they work offline and sync the changes made to the cloud when the user is back online. When a user works completely locally, some embodiments are still able to use local artificial intelligence (AI) model(s) 524 to optimize source code or build instructions on the local machine.

Some embodiments are collaborative, in that they facilitate multiple users working on the same codebase and are able to resolve conflicts in a seamless manner. If two users make changes to the same file and run a build on a server, then the combination of the AI and CRDT ensure that only one build runs. In some scenarios, the synchronization of the code and the build are also in lockstep so that there are no divergent builds.

Some embodiments use AI on the server side to optimize and recover when CRDTs do not resolve conflicts 134. In some cases, the AI includes a large language model fine-tuned to generate text in a programming language.

Some embodiments use eager caching on the client side so that even in case of a disconnection from the cloud a user is able to modify changes on their local filesystem.

In some embodiments, and end-to-end workflow proceeds as follows. A user starts a client-side component of the system on their local system. This is a standalone application able to run on different operating systems. The user mounts a cloud-based file system on their local system and is able to run a build process on their local system. The user is able to work offline and sync the changes made to the cloud when the user is back online. The system uses CRDTs to sync the changes made by different users in a seamless manner. In case of a disconnection from the cloud, a local AI model is able to generate the next steps in a build process. This allows the user to work offline and sync the changes made to the cloud when the user is back online. A server-side component of the system includes a cloud-based system able to run the build process and able to sync the changes made by different users. It uses a domain specific language as a build DSL, a rule engine, the CRDT, and the AI model to generate an optimal build configuration.

### Internet of Things

In some embodiments, the system 202 is, or includes, an embedded system such as an Internet of Things system. “IoT” or “Internet of Things” means any networked collection of addressable embedded computing or data generation or actuator nodes. An individual node is referred to as an internet of things device 101 or IoT device 101 or internet of things system 102 or IoT system 102. Such nodes are examples of computer systems 102 as defined herein, and may include or be referred to as a “smart” device, “endpoint”, “chip”, “label”, or “tag”, for example, and IoT may be referred to as a “cyber-physical system”. In the phrase “embedded system” the embedding referred to is the embedding a processor and memory in a device, not the embedding of debug script in source code.

IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage-RAM chips or ROM chips provide the only local memory; (e) no CD or DVD drive; (f) being embedded in a household appliance or household fixture; (g) being embedded in an implanted or wearable medical device; (h) being embedded in a vehicle; (i) being embedded in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP, Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

### Technical Character

The technical character of embodiments described herein will be apparent to one of ordinary skill in the art, and will also be apparent in several ways to a wide range of attentive readers. Some embodiments address technical activities such as representing source code edits using replicated data type 130 update 132 data structures, resolving 206 conflicts between competing updates 132, measuring 306 source code compliance with quality criteria 210 by executing tools 322, or executing a machine learning model 524, which are each an activity deeply rooted in computing technology. Some of the technical mechanisms discussed include, e.g., machine learning models 524, CRDTs 130, interfaces 326, 320, 432, and QFRDT software 302. Some of the technical effects discussed include, e.g., sharing of source code edits between different developer locations when a centralized source code repository is unavailable, and the automated transparent resolution of source code edit conflicts in a way that not only provides strong eventual consistency but also satisfies source code acceptance criteria. Thus, purely mental processes and activities limited to pen-and-paper are clearly excluded from the scope of any embodiment. Other advantages based on the technical characteristics of the teachings will also be apparent to one of skill from the description provided.

One of skill understands that edit conflict resolution outside the direct view and control of a human, in a computing network 108 or other computing system 102, is technical activity which cannot be performed mentally at all, and cannot be performed manually with the speed and accuracy required in computing systems. Hence, edit conflict resolution improvements such as the various examples of QFRDT functionality 204 described herein are improvements to computing technology. One of skill understands that attempting to manually resolve edit conflicts would create unacceptable delays in software development. People manifestly lack the speed, accuracy, memory capacity, and specific processing capabilities required to perform automated edit conflict resolution as taught herein.

Different embodiments provide different technical benefits or other advantages in different circumstances, but one of skill informed by the teachings herein will acknowledge that particular technical advantages will likely follow from particular embodiment features or feature combinations, as noted at various points herein. Any generic or abstract aspects are integrated into a practical application such as an IDE tool 122 or a source code editor tool 422, 122. One such tool is an enhanced GitHub Codespaces™ tool (mark of GitHub, Inc.), but practical applications of the teachings herein are not technologically limited to any particular vendor's products and services.

Some embodiments described herein may be viewed by some people in a broader context. For instance, concepts such as efficiency, reliability, user satisfaction, or waste may be deemed relevant to a particular embodiment. However, it does not follow from the availability of a broad context that exclusive rights are being sought herein for abstract ideas; they are not.

Rather, the present disclosure is focused on providing appropriately specific embodiments whose technical effects fully or partially solve particular technical problems, such as how to share source code edits when a centralized source code repository is not available, how to resolve conflicts between source code edits that were made by different developers at different locations, how to converge edits to a consistent source code version, and how to facilitate software quality as software source code is edited. Other configured storage media, systems, and processes involving efficiency, reliability, user satisfaction, or waste are outside the present scope. Accordingly, vagueness, mere abstractness, lack of technical character, and accompanying proof problems are also avoided under a proper understanding of the present disclosure.

### Additional Combinations and Variations

Any of these combinations of software code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, language models, prompts, motivating examples, operating environments, tools, peripherals, software process flows, identifiers, repositories, data structures, data selections, naming conventions, notations, control flows, or other implementation choices described herein. Any apparent conflict with any other patent disclosure, even from the owner of the present subject matter, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
LAN: local area network
OS: operating system
PaaS or PAAS: platform-as-a-service
RAM: random access memory
ROM: read only memory
SIEM: security information and event management
TPU: tensor processing unit
UEFI: Unified Extensible Firmware Interface
UI: user interface
WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Sharing a reference numeral does not mean necessarily sharing every aspect, feature, or limitation of every item referred to using the reference numeral. Omission of a reference numeral from a given piece of text does not necessarily mean that the content of a Figure is not being discussed by the text. The present disclosure asserts and exercises the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin (x)) or it may simply return without also providing a value (e.g., void functions).

“Service” as a noun means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

Herein, activity by a user refers to activity by a user device or activity by a user account or user session, or by software on behalf of a user, or by hardware on behalf of a user. Activity is represented by digital data or machine operations or both in a computing system. Activity within the scope of any claim based on the present disclosure excludes human actions per se. Software or hardware activity “on behalf of a user” accordingly refers to software or hardware activity on behalf of a user device or on behalf of a user account or a user session or on behalf of another computational mechanism or computational artifact, and thus does not bring human behavior per se within the scope of any embodiment or any claim.

“Digital data” means data in a computing system, as opposed to data written on paper or thoughts in a person's mind, for example. Similarly, “digital memory” refers to a non-living device, e.g., computing storage hardware, not to human or other biological memory.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” may also be used as a patent law term of art, e.g., in describing a process claim as opposed to a system claim or an article of manufacture (configured storage medium) claim. Similarly, “method” is used herein primarily as a technical term in the computing science arts (a kind of “routine”) but it is also a patent law term of art (akin to a “method”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Edit conflict resolution operations such as assessing 306 candidates by running quality measurement tools 322, applying 824 CRDT resolution rules, creating 830 snippet versions, loading 832 a snippet into a user interface 432, and many other operations discussed herein (whether recited in the Figures or not), are understood to be inherently digital and computational. A human mind cannot interface directly with a CPU or other processor, or with RAM or other digital storage, to read and write the necessary data to perform the edit conflict resolution steps 800 taught herein even in a hypothetical situation or a prototype situation, much less in an embodiment's real world large computing environment, e.g., an internet-connected environment. This would all be well understood by persons of skill in the art in view of the present disclosure. Moreover, one of skill understands that QFRDT functionality cannot be implemented using merely with conventional tools and steps, because actual implementation requires the integration of assessment 306 with RDTs 130 and other teachings which were first provided in the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user, and indicates machine activity rather than human activity. Indeed, a user may not even realize that a proactive step by an embodiment was possible until a result of the step has been presented to the user. Except as otherwise stated, any computational and/or automatic step described herein may also be done proactively.

“Based on” means based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

“At least one” of a list of items means one of the items, or two of the items, or three of the items, and so on up to and including all N of the items, where the list is a list of N items. The presence of an item in the list does not require the presence of the item (or a check for the item) in an embodiment. For instance, if an embodiment of a system is described herein as including at least one of A, B, C, or D, then a system that includes A but does not check for B or C or D is an embodiment, and so is a system that includes A and also includes B but does not include or check for C or D. Similar understandings pertain to items which are steps or step portions or options in a method embodiment. This is not a complete list of all possibilities; it is provided merely to aid understanding of the scope of “at least one” that is intended herein.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this disclosure discusses various data values and data structures, and recognize that such items reside in a memory (RAM, disk, etc.), thereby configuring the memory. One of skill will also recognize that this disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational step on behalf of a party of interest, such as accepting, accessing, applying, assessing, computing, converging, creating, determining, differing, executing, getting, identifying, interfacing, loading, locating, performing, preparing, prioritizing, prompting, ranking, receiving, rejecting, resolving, sending, specifying, submitting, supplying (and accepts, accepted, accesses, accessed, etc.) with regard to a destination or other subject may involve intervening action, such as the foregoing or such as forwarding, copying, uploading, downloading, encoding, decoding, compressing, decompressing, encrypting, decrypting, authenticating, invoking, and so on by some other party or mechanism, including any action recited in this document, yet still be understood as being performed directly by or on behalf of the party of interest. Example verbs listed here may overlap in meaning or even be synonyms; separate verb names do not dictate separate functionality in every case.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other storage device or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory and computer readable storage devices are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### Remarks Regarding Reference Numerals

Reference numerals are provided for convenience and in support of the drawing figures and as part of the text of the specification, which collectively describe aspects of embodiments by reference to multiple items. Items which do not have a unique reference numeral may nonetheless be part of a given embodiment. For better legibility of the text, a given reference numeral is recited near some, but not all, recitations of the referenced item in the text. The same reference numeral may be used with reference to different examples or different instances of a given item.

The following remarks pertain to particular reference numerals:
100 operating environment, also referred to as computing environment; includes one or more systems 102
101 machine in a system 102, e.g., any device having at least a processor 110 and having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202
106 peripheral device
108 network generally, including, e.g., LANs, WANs, software-defined networks, clouds, and other wired or wireless networks
110 processor or non-empty set of processors; includes hardware
112 computer-readable storage medium, e.g., RAM, hard disks; also referred to as storage device
114 removable configured computer-readable storage medium
116 instructions executable with processor; may be on removable storage media or in other memory (volatile or nonvolatile or both)
118 digital data in a system 102; data structures, values, source code, and other examples are discussed herein
120 kernel(s), e.g., operating system(s), BIOS, UEFI, device drivers; also refers to an execution engine such as a language runtime
122 software tools, software applications, security controls; hardware tools; computational
124 software source code, as represented within a computing system and hence digital
126 display screens, also referred to as “displays”
128 computing hardware not otherwise associated with a reference numeral 106, 108, 110, 112, 114
130 replicated data type, as represented within a computing system
132 edit update, as represented or effectuated in a computing system
134 conflict between edit updates, as represented or effectuated in a computing system
136 cloud, also referred to as cloud environment or cloud computing environment
202 enhanced computing system, i.e., system 102 enhanced with functionality 204 as taught herein
204 QFRDT functionality (also referred to as code-quality-focused replicated data type functionality 204, or functionality 204), e.g., software or specialized hardware which performs or is configured to perform steps 306 and 206 with RDTs, or steps 820 and 824, or any software or hardware which performs or is configured to perform an edit conflict resolution activity with RDTs first disclosed herein, or to perform a novel method 800 first disclosed herein
700 flowchart; 700 also refers to QFRDT methods that are illustrated by or consistent with the FIG. 7 flowchart or any variation of the FIG. 7 flowchart described herein; all QFRDT method steps are computational, not human activity
800 flowchart; 800 also refers to QFRDT methods that are illustrated by or consistent with the FIG. 8 flowchart, which incorporates the FIG. 7 flowchart and all other steps taught herein, or methods that are illustrated by or consistent with any variation of the FIG. 8 flowchart described herein; all QFRDT method steps are computational, not human activity
844 any step or item discussed in the present disclosure that has not been assigned some other reference numeral; 844 may thus be shown expressly as a reference numeral for various steps or items or both, and may be added as a reference numeral (in the current disclosure or any subsequent patent application which claims priority to the current disclosure) for various steps or items or both without thereby adding new matter

### CONCLUSION

Repositories 424 operate in an architecture with a centralized storage location for source code versions. When internet connectivity is lost, or the repository is otherwise unavailable, developers can continue editing a local copy of their code, but they lack adequate tools to share their changes with other developers who are working elsewhere on the same project.

Some collaborative natural language text editors use CRDTs to spread text updates in a peer-to-peer manner that does not require a centralized storage location. Some CRDTs include commutative replicated data types and conflict-free replicated data types. Some CRDTs provide strong eventual consistency between copies of a natural language text file. But CRDT mechanisms for resolving conflicts between natural language text updates are not designed to work well with source code.

Some embodiments integrate CRDT convergence mechanisms with assessments of potential source code update conflict resolutions based on source code quality criteria, such as syntactic correctness and consistency with surrounding source code. Users of integrated development environments and other source code editors will benefit from the collaboration support provided by embodiments taught herein.

Embodiments are understood to also themselves include or benefit from tested and appropriate security controls and privacy controls such as the General Data Protection Regulation (GDPR). Use of the tools and techniques taught herein can be used together with such controls.

Although technology of particular vendors is used in some motivating examples, the teachings herein are not limited to use in technology supplied or administered by any particular vendor. Under a suitable license, for example, the present teachings could be embodied in software or services provided by various software development solution providers.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of platforms or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; it is not required to recite every nuance within the claims themselves as though no other disclosure was provided herein.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A method of collaborative software development performed in a computing system, the method comprising automatically:
locating at least two updates to a replicated data type which represents at least one source code snippet;
assessing at least one candidate resolution of a conflict between the updates against at least one source code acceptance criterion; and
executing a deterministic conflict resolution in response to at least a result of the assessing, the executing comprising creating a version of the at least one source code snippet; and
supplying the created version to a source code editor.

2. The method of claim 1, wherein the assessing comprises:
provisionally performing a first one of the two updates to produce a first provisionally updated source code snippet;
provisionally performing a second one of the two updates to produce a second provisionally updated source code snippet;
determining that the first provisionally updated source code snippet satisfies the source code acceptance criterion and determining that the second provisionally updated source code snippet does not satisfy the source code acceptance criterion; and
specifying the conflict resolution as an acceptance of the first one of the two updates and a rejection of the second one of the two updates.

3. The method of claim 1, wherein the assessing comprises:
provisionally performing each of a plurality of conflicting updates to produce respective provisionally updated source code snippets;
ranking each provisionally updated source code snippet according to at least one source code acceptance criterion;
identifying a best ranked update according to at least the ranking; and
specifying the conflict resolution as acceptance of the best ranked update and rejection of the other conflicting updates.

4. The method of claim 1, wherein a condition of the source code acceptance criterion specifies at least one of:
the candidate resolution includes a candidate source code snippet which is syntactically correct;
the candidate resolution includes a candidate source code snippet which is in a same programming language as a context source code;
the candidate resolution includes a candidate source code snippet which is in a same programming style as a context source code;
the candidate resolution includes a candidate source code snippet which includes a variable identifier that is also in a context source code;
the candidate resolution includes a candidate source code snippet which invokes an imported library that is also invoked in a context source code;
the candidate resolution includes a candidate source code snippet which has greater usage in a context source code than any other candidate source code snippet of any competing candidate resolution;
the candidate resolution includes a candidate source code snippet which has greater similarity to a context source code than any other candidate source code snippet of any competing candidate resolution, where similarity is measured by a specified software similarity metric; or
the candidate resolution includes a candidate source code snippet which has lower linting tool error count in a context source code than any other candidate source code snippet of any competing candidate resolution.

5. The method of claim 1, wherein a condition of the source code acceptance criterion specifies that the candidate resolution includes a candidate source code snippet which has a better source code quality measurement tool score from a specified source code quality measurement tool than any other candidate source code snippet of any competing candidate resolution.

6. The method of claim 1, wherein assessing the candidate resolution comprises automatically:
submitting an assessment prompt to a language model, the assessment prompt representing at least a portion of the candidate resolution, the assessment prompt specifying the source code acceptance criterion and requesting an assessment of the candidate resolution against the source code acceptance criterion;
getting from the language model at least a portion of the result of the assessing; and
executing the deterministic conflict resolution in response to at least the portion of the result of the assessing.

7. The method of claim 1, further comprising automatically:
submitting a generation prompt to a language model, the generation prompt representing at least the updates, the generation prompt requesting a candidate source code snippet of the candidate resolution;
receiving the candidate source code snippet of the candidate resolution from the language model; and
assessing at least the candidate source code snippet of the candidate resolution against the at least one source code acceptance criterion.

8. A collaborative software development computing system, comprising:
at least one digital memory;
at least one processor in operable communication with the at least one digital memory, the at least one processor configured to execute a collaborative software development method, the method comprising: locating at least two updates to a replicated data type which represents at least one source code snippet, assessing at least one candidate resolution of a conflict between the updates against at least one source code acceptance criterion, and executing a deterministic conflict resolution in response to at least a result of the assessing.

9. The system of claim 8, further comprising an interface to a language model, and wherein the processor is further configured to perform at least one of:
preparing a generation prompt which requests a candidate source code snippet of the candidate resolution, submitting the generation prompt to the language model via the interface, and receiving the candidate source code snippet from the language model via the interface; or
preparing an assessment prompt which contains a candidate source code snippet of the candidate resolution, submitting the assessment prompt to the language model via the interface, and getting a quality assessment of the candidate source code snippet from the language model via the interface.

10. The system of claim 8, further comprising an interface to a source code quality measurement module, and wherein the processor is further configured to submit a candidate source code snippet of the candidate resolution to the source code quality measurement module via the interface, and to get a quality assessment of the candidate source code snippet from the source code quality measurement module via the interface.

11. The system of claim 8, wherein the replicated data type comprises at least one of:
a commutative replicated data type;
a conflict-free replicated data type;
an operational transform replicated data type;
an operation-based replicated data type;
a state-based replicated data type; or
a delta state replicated data type.

12. The system of claim 8, wherein the replicated data type comprises at least one of:
a grow-only counter;
a positive-negative counter;
a last-write-wins register;
a multi-value register;
a grow-only set;
a two-phase set;
an enable-wins flag;
a disable-wins flag;
a grow-only data structure; or
an observed-remove data structure.

13. The system of claim 8, wherein the deterministic conflict resolution comprises at least one of:
a last-write-wins conflict resolution; or
an observed-remove conflict resolution.

14. The system of claim 8, wherein the collaborative software development computing system is configured as a peer in a peer-to-peer architecture.

15. The system of claim 8, wherein the collaborative software development computing system further comprises a source code editor having a user interface, executing the deterministic conflict resolution creates a version of the at least one source code snippet, and the at least one processor is configured to upon execution load the created version into the source code editor user interface.

16. A computer-readable storage device configured with data and instructions which upon execution by a processor perform a collaborative software development method in a computing system, the method comprising automatically:
locating at least two updates to a commutative replicated data type which represents at least one source code snippet, each update having a respective origin location and a respective author, each update representing a respective change made to a respective copy of a source code by the respective author at the respective location, one of the updates being in a conflict with another of the updates;
assessing at least one candidate resolution of the conflict between the updates against at least one source code acceptance criterion; and
executing a deterministic conflict resolution in response to at least a result of the assessing.

17. The computer-readable storage device of claim 16, characterized by at least one of:
each update is received free of a source code repository commit request;
neither update is received with an associated source code repository commit identifier;
the method avoids sending either update to a source code repository of a version control system;
the method is performed outside a source code repository of a version control system;
the method provides a strong eventual consistency to multiple versions of a file of source code;
the method converges multiple versions of a file of source code on multiple devices; or
the method operates independently from any source code repository commit operation.

18. The computer-readable storage device of claim 16, wherein executing the deterministic conflict resolution creates a version of the at least one source code snippet, and the method further comprises loading the created version into a source code editing tool on the computing system.

19. The computer-readable storage device of claim 16, wherein the method comprises at least one of:
assessing the at least one candidate resolution against multiple source code acceptance criteria; or
ranking each of a plurality of candidate resolutions according to the at least one source code acceptance criterion, and resolving the conflict between the updates according to a best-ranked candidate resolution.

20. The computer-readable storage device of claim 16, wherein a respective instance of the method is performed by the respective author at the respective location by a respective tool during a time period in which access to a repository which contains at least one version of the source code is unavailable at each respective location.
